(19) United States
(12) Patent Application Publication
(10) Pub. No.: US 2020/0118045 A1
(43) Pub. Date: Apr. 16, 2020

(54) SYSTEM AND METHOD FOR AUTOMATIC RESERVATION OF MEETING ROOMS

(71) Applicant: MICROSOFT TECHNOLOGY LICENSING, LLC, Redmond, WA (US)

(72) Inventors: Charlie Ricafort CHUNG, Tacoma, WA (US); Christoffer Benjamin ROSEN, Redmond, WA (US); Abhishek Kumar CHATURVEDI, Redmond, WA (US); Binit Kumar JHA, Kirkland, WA (US); Lamia BENMOUFFOK, Kirkland, WA (US); Ricardo Alberto Rosales GUERRERO, Seattle, WA (US); Mohit VERMA, Kirkland, WA (US); Elias KAPLAN, Redmond, WA (US)

(73) Assignee: MICROSOFT TECHNOLOGY LICENSING, LLC, Redmond, WA (US)

(21) Appl. No.: 16/162,351

(22) Filed: Oct. 16, 2018

(51) Int. Cl. G06Q 10/02; G06Q 10/10

(52) U.S. Cl. CPC G06Q 10/02; G06F 3/04847; G06Q 10/1095

(57) ABSTRACT

A method and system for automatically reserving a room for a meeting is disclosed, in which a user is offered an option for enabling automatic room reservation during the creation of a scheduled meeting. The user can specify the time of the meeting, as well as preferences for the type of room that should be selected. The system can also ensure the availability of a suitable room for recurring meetings.

### BACKGROUND

There are a number of tools presently available for enabling people to conduct live meetings, conferences, presentations, or other types of gatherings. Typically, such meetings involve an organizer initially scheduling the meeting, identifying a location for the meeting, and sending invitations to the desired participants. Each invited participant can be provided a subject of the meeting, a time and date for the meeting, a location of the meeting and in some cases a list of other participants. An invited participant is then expected to attend the meeting at the scheduled time and place.

In order for meeting spaces to be conducive to group discussions and presentations, the availability of, or access to, specific rooms with various resources can be of great significance to meeting organizers and participants. For example, meeting participants frequently expect to make use of a telephone, computer, or other communication device that connects to a conference system or server. The meetings may also include an audio component and/or a visual component, such as a shared presentation, video, whiteboard, or other multimedia, text, graphics, etc. that require a particular technology component. Furthermore, individual participants may have their own room access and furniture needs that must be accommodated.

Organizers can search for rooms that provide the resources and/or configuration needed and are available at the desired time, but such a task is often burdensome and limited to the organizer's own knowledge of the available rooms, as well as company policies regarding room reservations. Such limitations can diminish the ability of organizations to maximize use of their own resources.

### SUMMARY

A reservation system, in accordance with a first aspect of this disclosure, includes at least one processor and one or more computer readable media. The computer readable media include instructions which, when executed by the at least one processor, cause the at least one processor to cause to be displayed, to a user, a first user interface including a first selectable option authorizing an automatic room reservation for at least a first meeting event scheduled to occur during a first time period. The instructions also cause the at least one processor to record, in response to a first user selection of the first selectable option, a first authorization to automatically reserve a room for the first meeting event. The instructions further cause the at least one processor to automatically initiate, in response to the recorded first authorization and at a time prior to the first meeting event, a first search for at least a first room that is available during the first time period. In addition, the instructions cause the at least one processor to automatically reserve the first room for use during the first time period.

A method of reserving a room for a meeting, in accordance with a second aspect of this disclosure, includes causing to be displayed, to a user, a first user interface. The first user interface includes a first selectable option authorizing an automatic room reservation for at least a first meeting event scheduled to occur during a first time period. The method also includes recording, in response to a first user selection of the first selectable option, a first authorization to automatically reserve a room for the first meeting event. In addition, the method includes automatically initiating, in response to the recorded first authorization and at a time prior to the first meeting event, a first search for at least a first room that is available during the first time period. Furthermore, the method involves automatically reserving the first room for use during the first time period.

A method of facilitating room selection for a meeting, in accordance with a third aspect of this disclosure, includes causing to be displayed, to a user, a first user interface. The first user interface includes a first input field for scheduling a time for a first meeting event and a second input field for selecting required meeting room resources. The method also includes receiving a start time and an end time for the first meeting event via the first input field. In addition, the method includes receiving a first room criterion via the second input field. The method further includes automatically initiating, in response to receiving the start time, the end time, and the first room criterion, a first search for one or more rooms that are available for use during the first meeting event and meet the first room criterion. The method also includes causing to be displayed, to the user, a list of suggested meeting rooms, the list of suggested meeting rooms including a first room of the one or more rooms that is available for use during the first meeting event and meets the first room criterion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A-1C each illustrate a user scheduling a meeting and an implementation of a system for automatic identification of a location for the meeting;

FIG. 2 is an implementation of a meeting scheduling application interface configured to automatically reserve future meetings;

FIG. 3 is an implementation of a calendar and a plurality of meeting invitations in which rooms have been automatically reserved;

FIG. 4 is an implementation of a meeting scheduling application interface configured to automatically present suggested meeting locations;

FIG. 5A is an implementation of a first interface presenting suggested meeting locations and FIG. 5B is an implementation of a second interface presenting favorites listing of rooms for a user;

FIG. 6 is an implementation of a meeting scheduling application interface configured to automatically reserve future meetings;

FIG. 7 is an implementation of a calendar and a plurality of meeting invitations in which rooms have been automatically reserved;

FIG. 8A is an implementation of a meeting scheduling application interface configured to automatically present suggested meeting locations and FIG. 8B is an implementation of a meeting scheduling application interface configured to automatically reserve future meetings;

FIG. 9 is a schematic flow diagram illustrating an implementation of a process for automatically reserving a room for a meeting;

FIG. 10 is a flow diagram of an implementation of a process for automatic reservation of a room;

FIG. 11 is a block diagram of an example computing device, which may be used to provide implementations of the mechanisms described herein; and

FIG. 12 is a block diagram illustrating components of an example machine configured to read instructions from a machine-readable medium.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following implementations introduce a method and system for automatic reservation or booking of a room for a scheduled meeting event. A meeting organizer may be offered options during the scheduling process (or at other stages or instances prior to the scheduled meeting) for enabling automatic room booking. Traditionally, room booking has included a series of steps where users can: (1) schedule a meeting; (2) identify a list of invitees; (3) select a date and time for the meeting; (4) search for available rooms of the desired size that include any resources necessary for the meeting; and (5) generate and send an invitation to participant(s). However, in many situations, organizers can be unaware of room status changes that occur between the time of scheduling and the meeting event. In addition, organizations frequently establish their own policies that can limit an organizer's ability to plan for events that occur regularly or will not occur until a more distant (future) date. Organizers can be frustrated by the inability to plan ahead for such recurring meetings or meetings being planned further into the future. In some cases, an organizer can forget they have an upcoming meeting in which a room has not been booked, and when they return later to make the booking they are not able to find a room suited to their needs, if at all. Organizers can be required to return to the scheduling system repeatedly, hoping for a cancellation of another booking for the desired room. In addition, if the meeting has been rescheduled to a different time, the room booking may not be updated, and result in a great deal of stress and delay to participants.

Even in cases where the organizer has booked a room, they may encounter situations where the room is under maintenance or otherwise undergoes changes that make the room no longer suitable for their needs, or where the resources needed for the meeting have changed. Similarly, if the number of invitees or expected attendees changes, the previously reserved room may no longer be suitable. Furthermore, in cases where the organizer is no longer in the employment of the company where the meeting was to be held, or is otherwise no longer available in the role of meeting organizer and fails to cancel the meeting before their departure, the room reservation will be (incorrectly) held, resulting in an inadvertent waste of resource(s). There may also be situations in which a recurring meeting is scheduled, but the participants are travelling or working off-site; in such a case, the original room reservation will no longer be useful, and a cancellation should occur, or a remote site may instead be needed.

As will be discussed in detail below, the disclosed implementations describe a system and method that provide straightforward solutions to these issues, providing for the automatic reservation of meeting rooms, as well as the automatic management of reserved rooms and other shared resources. The system can be configured to accommodate updates and other changes in the meeting configuration, room availability, or other user preferences. This mechanism will be provided to the user in a manner that maximizes convenience and efficiency. For example, the option to automatically book a room can be presented to an organizer as he or she is scheduling the meeting, during their review of a previously scheduled or recurring meeting, and/or while viewing reminders, calendar updates or previews, or other items associated with meeting preparation, information, or notifications. By removing the inconvenience of having to search for available rooms with the desired facilities or remembering to return to the meeting listing to update the room booking once the organization policies permit such a booking meeting, a user can make better use of their time, easily accommodate the needs of their presentations and participants, and optimize the management of resources in their organization. Furthermore, in some implementations, a user can customize the automated booking process, per their preferences, by identifying their favorite rooms or locations, or even make reference to favorite rooms of the meeting's other participants.

In general, a meeting event (“meeting”) refers to a real time, or near-real time, in-person use of a physical space. In general, this can involve an in-person communication session between two or more participants. However, in some implementations, only one person may be present in a room and connect to another participant via a telecommunications device, or a single person may wish to make use of a room at a specific time and day for their own purposes. Thus, the term meeting can encompass any event, activity, gathering, assembly, class, conference, convention, summit, session, get-together, congregation, reunion, or the like that may be prescheduled and includes the use of a particular resource. It should further be understood that references to the term “room” encompasses not only enclosed spaces in physical structures or buildings, but any physical space that can be the site of a meeting, enclosed, open, indoors, or outdoors. The room can also include a sub-structure or component(s) within a room, such as a cubicle, conference table, or other designated spaces or resources.

In addition, the term scheduled meeting as used generally refers to a meeting that has been scheduled for a particular date/time or has been designated to occur at a recurring day/time. It should be understood that the disclosed implementations may also be applicable to meetings that have not yet been scheduled. For example, as a user is creating the meeting, or before the meeting invite has been finalized.

As noted above, the option to automatically reserve a room for a meeting can be presented during various workflow instances of a meeting lifecycle. For example, a meeting lifecycle includes the time prior to a scheduled meeting. The workflow instances for a meeting therefore include any step, event, action, or communication associated with the meeting, and can include but are not limited to creation of the meeting, receipt of a meeting invite, communications between invitees of the meeting, meeting documents shared with invitees, agenda or calendar notifications related to the meeting, meeting updates, and so forth. Furthermore, the following implementations may refer to the concept of “first view”, which refers to an instance in which a participant first engages with information for the meeting; for example, while creating the meeting event, or while initially opening or viewing an invitation.

In general, usage of the terms “automatically reserve”, “automatically book”, “auto-reserve”, or “auto-book” refer to the capability of a system to automatically assign and hold one or more room or location options to a user for use at a predetermined date and time and/or as specified conditions are met. For example, if the auto-reserve feature is enabled, the system can be configured to search for a room that meets the organizer's preferences and is available at the stated date/time, present them to the organizer as recommendations, and/or automatically reserve the room without requiring further confirmation from the organizer. As another example, the system may not immediately identify a room for a specific meeting during the meeting creation process, but can be configured to continue searching ‘offline’ for an appropriate room and update the meeting listing when a suitable room is found and/or successfully booked. In addition, the system can be configured to generate and/or transmit notifications to the organizer and/or invitees to provide up-to-date information about the room location.

References to a meeting application, a scheduling application, an organizer application, or simply “application” may be understood to refer to any software applications configured to provide a means of scheduling, viewing, modifying, or organizing a meeting and corresponding meeting room, and/or communicating or transmitting or receiving data associated with the meeting. This can include any type of electronic calendar or electronic scheduling system that is capable of scheduling meetings or appointments. Some such programs can include Skype®, Microsoft Teams®, Microsoft Outlook®, GoToMeeting®, WebEx®, Zoom®, Join.Me®, Calendy®, Boomerang Calendar®, FreeBusy®, NeedToMeet®, Meekan®, Google Calendar®, GoogleHangouts®, AnyMeeting® and other applications that can provide meeting tools and/or facilitate communication or collaboration online. These are non-limiting examples, and any other communication-related application may benefit from the disclosed implementations. Specific references to a software application by name throughout this description should not therefore be understood to limit the use of the proposed systems and methods. It should further be understood that in some implementations, the application used to enable an auto-booking function may differ from the application used to schedule the meeting, while in other implementations, they may be the same.

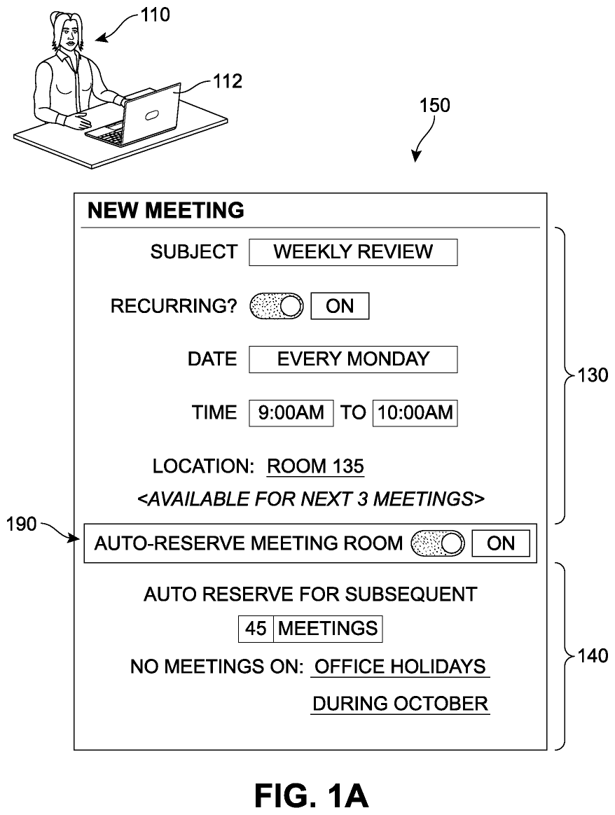

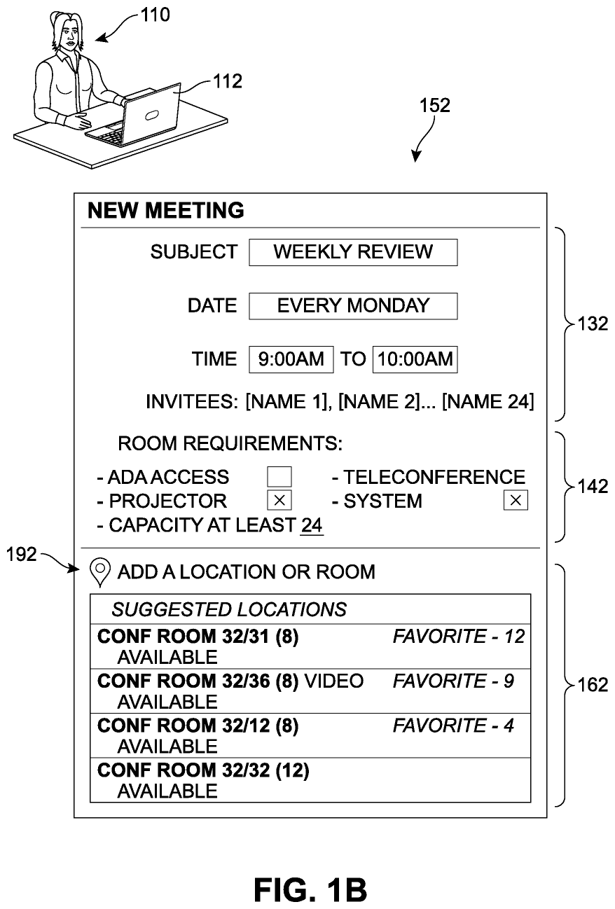

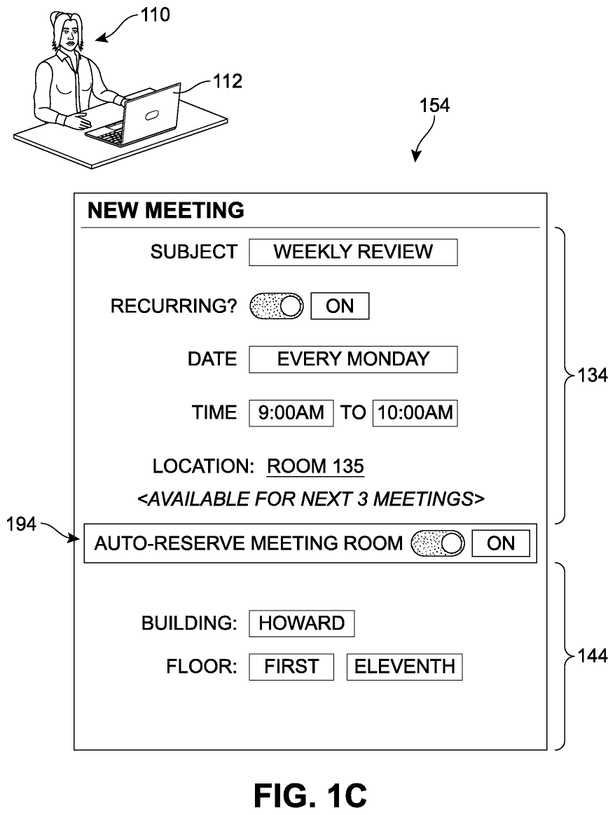

In order to better introduce the systems and methods to the reader, FIGS. 1A-1C present three high-level examples of a representative meeting creation interface (“scheduling interface”) for implementing a meeting room management system. In some implementations, a “new” meeting can be scheduled via a native control, such as a scheduling interface for a scheduling application (“application”). For example, a “native control” refers to a mechanism for communicating content through a client application to an application user. For example, native controls may include pop-up windows that may be presented to a user as software application user interfaces (UIs), interactive buttons, or other objects that may be shown to a user through native application UIs, as well as mechanisms that are native to a particular application for presenting associated content with those native controls. In different implementations, a native control can include any other type of user interface such as a dialog box, notification, alert, reminder, email, instant message, or other application communication or presentation means. In addition, a “trigger event” or “triggering event” refers to an event (or specific sequence of events) associated with a particular use of an application, which corresponds to a selection of an option offered via a native control, or an event that matches a condition. In FIGS. 1A-1C, the triggering event may be understood to include a ‘click’, toggle, voice command, or other input actions (such as a mouse left-button or right-button click, a touchscreen tap, a selection of data, or other input types).

As will be described below, in different implementations, the scheduling interface can include a plurality of fields for receiving meeting-related input, including but not limited to a title or subject field, a location field, a start time and end time field(s), a meeting details, notes, or description field, and/or an invitees field. In some implementations, the application can be configured to present additional or alternate options to a user. It should be understood that a Settings option may be made available on each of the user interfaces described herein, whether or not explicitly identified.

In different implementations, each scheduler interface can be accessed by one or more computing device end-users, or simply “users”. As an example, one type of user may be a meeting organizer. An organizer 110 is depicted in FIGS. 1A-1C in the process of setting up a meeting. In the implementation of FIG. 1A, the organizer 110 is accessing a first scheduler user interface (“first scheduler”) 150 that is presented via a first device 112. It can be understood that the first device 112 is configured for connection to a network. As first user 110 initially schedules and creates the meeting via the first scheduler 150, the first user 110 may be presented with a first selectable option (“first option”) 190 to enable auto-booking of a room for the meeting they are currently creating.

The first option 190 in FIG. 1A is shown here in an “ON” mode as a result of the first user's selection of the option, thereby enabling or activating the auto-book function. It should be understood that a user may also deactivate the option by switching the first option 190 back to the OFF position. However, in other implementations, the application may present the user with the auto-book function already activated, as a default, and the user can disable the option if desired. An organizer can thereby consider and define the logistics of the meeting (see a first interface portion 130), and make a choice as to what type of room is required for the meeting, how far in advance they wish to schedule it, and whether they wish to have the room automatically reserved for this particular event or series of events.

It should be understood that the text and specific wording shown in the figures are for purposes of illustration only and in no way limit the manner by which the application may communicate or receive information. In addition, while the first selectable option 190 is positioned beneath or below the first interface portion 130 in FIG. 1A, it should be understood that in other implementations, the first selectable option 190 or other fields and options may appear differently and/or may be displayed or generated anywhere else on the screen(s) associated with the client's system, including spaced apart from, adjacent to, or around the scheduler user interfaces. In other words, the figures present only one possible layout of the interface, and do not in any way limit the presentation arrangement of any of the disclosed features.

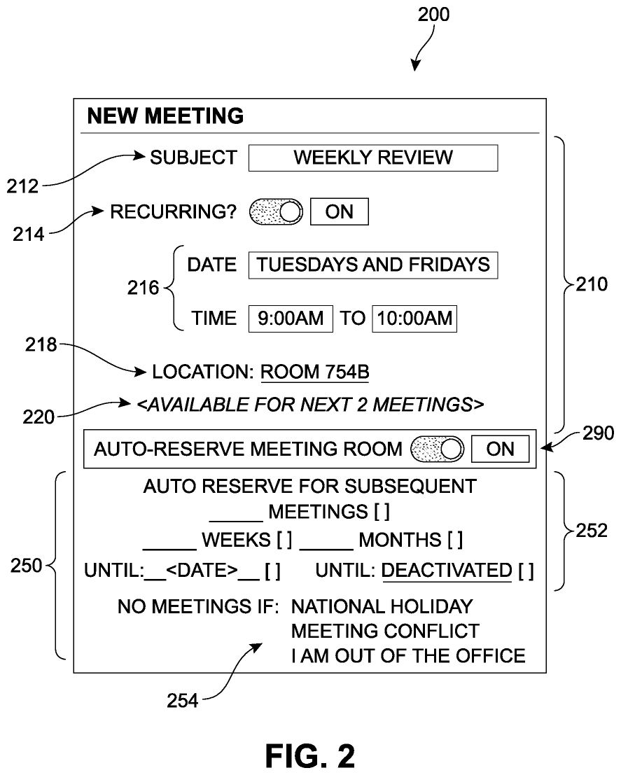

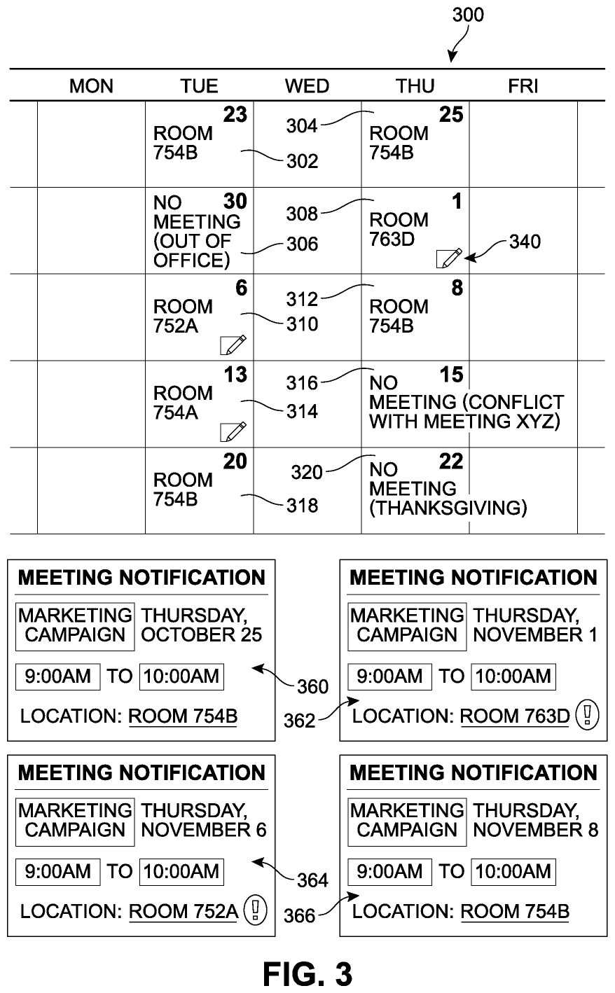

In some implementations, a scheduler interface can also offer one or more auto-booking preferences. As one example, a second interface portion 140 is shown below first option 190, and presents options such as a number of meetings for which rooms should be auto-booked, or which dates or periods in which no rooms should be booked (e.g., “blackout dates”). Additional details regarding such preferences will be described below with reference to FIGS. 2 and 3. By enabling the auto-reserve function, a user can delegate responsibility of selecting a room for the meeting (or series of meetings) to a kind of virtual booking agent, saving themselves both time and effort.

Another implementation of a meeting management system is depicted in FIG. 1B, where the organizer 110 is shown accessing a second scheduler user interface (“second scheduler”) 152 that is presented via first device 112. As the first user 110 initially schedules and creates a meeting via the second scheduler 152, the first user 110 may further be presented with an opportunity to identify the desired (or required) features of the meeting room (see a resources selector portion 142). Such options can include the availability of accommodations for those with special needs (“ADA Access”), Projector availability, Teleconference system availability, and room capacity. A wide variety of other preferences may also (or instead) be offered or received by the application to filter or guide the room choices that may be automatically suggested by the system for the meeting. In addition, the system can make reference to previous selections by the user, or frequently booked rooms for this meeting or organizer, and/or a list of favorites for this user or other users, to determine which rooms are most likely to fit the organizer's needs. In some implementations, such suggestions can be shown as a drop-down list 162 and/or appear as an auto-populate response in a location field 192, for example; however, in other implementations, the auto-suggested rooms may be provided by reference to a map or another interface.

A third implementation of a meeting management system is depicted in FIG. 1C, where the organizer 110 is shown accessing a third scheduler user interface (“third scheduler”) 154 that is presented via first device 112. As the first user 110 initially schedules and creates a meeting via the third scheduler 154, the first user 110 may further be presented with a second selectable option (“second option”) 194 to enable auto-booking of a room for the meeting they are currently creating. The second option 194 in FIG. 1C is shown here in an “ON” mode as a result of the first user's selection of the option, thereby enabling or activating the auto-book function. It should be understood that a user may also deactivate the option by switching the second option 194 back to the OFF position. An organizer can thereby consider and define the logistics of the meeting (see a third interface portion 134), and whether they wish to have the room automatically reserved for this particular event or series of events.

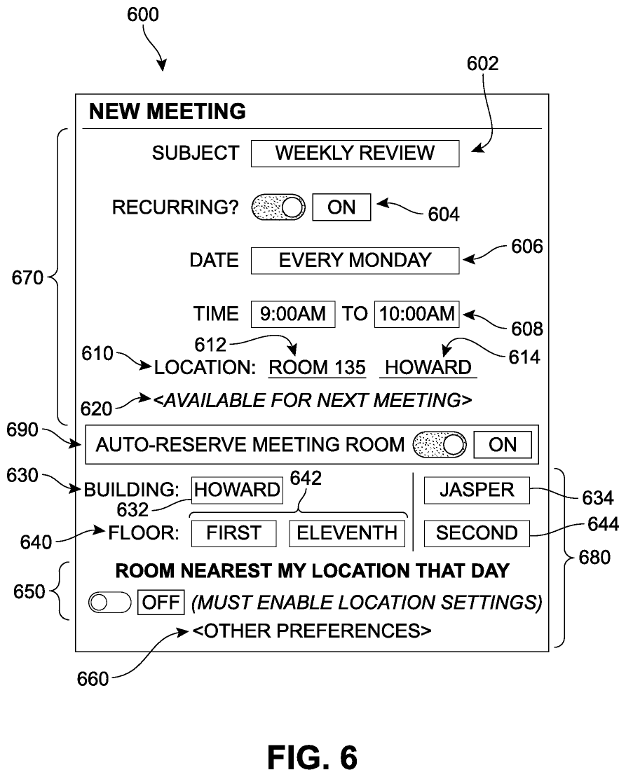

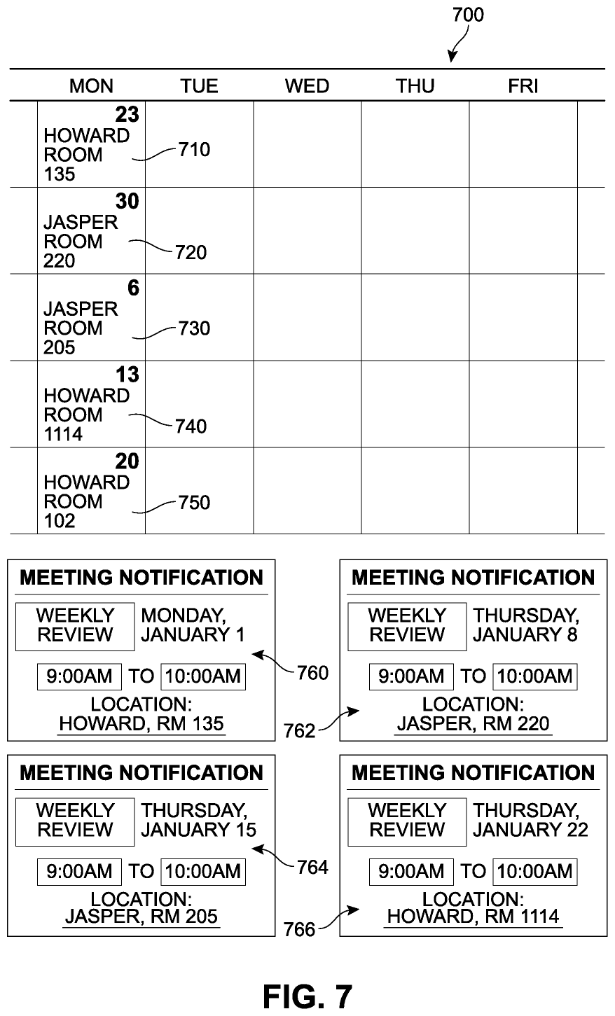

As noted above, a scheduler interface can also offer one or more auto-booking preferences. As one example, a fourth interface portion 144 is shown below second option 194, and presents options such as the building in which the meeting room should be located and the floors of the building that include rooms that may be auto-booked. In other words, a user can ‘vaguely’ or broadly set a boundary or limitation on the pool of rooms that may be considered by the system and auto-booked. This feature can be very attractive to users who often do not need or care to specify a room but simply want assurance that a room will be booked in a general location. Additional details regarding this process will be described below with reference to FIGS. 6 and 7.

As noted above with reference to FIG. 1A, in some implementations, a scheduler interface can be configured with an option to auto-reserve a meeting room at the time of the meeting creation. Another example of such a system is illustrated in FIG. 2 by a representative first meeting user interface (“first interface”) 200. The first interface 200 includes a meeting itinerary portion 210, which can include a variety of fields or options allowing an organizer to input the details of the planned meeting. In the example of FIG. 2, these include a subject field 212, an option 214 to identify this meeting as a recurring event, a set of date/day/time fields 216, and a location field 218. Other implementations may omit one or more of these fields, and/or include additional field types.

In one implementation, a user may manually input or otherwise designate a room or space that the meeting should occur. The user can input a room or space identifier (here shown as “Room 754B”) directly into the location field 218. In some implementations, the system may update the display of the first interface 200 in real-time to inform the user the upcoming availability of the selected room for the date/time chosen. In this example, the user is shown that Room 754B is available for the next two meetings of this recurring event series. In other words, Room 754B is confirmed for use during the first meeting and the second meeting (e.g., the next Tuesday and the next Friday), but cannot be confirmed beyond these two meetings.

In order for an organizer to confidently plan ahead for all foreseeable future meetings beyond—in this case—the second meeting, there is strong motivation to ensure each of those meetings will have a suitable room booked in advance of each meeting. However, an organizer faces an onus in trying to ‘keep up’ with each week of meetings and updating the calendar and event details as a particular room becomes available, repeatedly reviewing the room resource(s) status to see if a desired room has opened up, as well as ensuring each participant is informed about updates or changes in location for each event.

The proposed implementation allows the organizer to relinquish the burden of resource management for all future meetings. In FIG. 2, a selectable auto-reserve option 290 is selected (“ON”), thereby enabling or activating the auto-book function. It should be understood that a user may also deactivate the option by switching the auto-reserve option 290 back to the OFF position. The system can receive the information defining the meeting parameters, such as the types of data presented in meeting itinerary portion 210, as well as other parameters that can characterize the meeting, to help guide its search for a room.

In some implementations, additional input received by the system can fine-tune the auto-reserve mechanism. In FIG. 2, an auto-reserve portion 250 that may be made visible or active when the auto-reserve option 290 has been selected, or may be available as a default is illustrated. In this example, the organizer is able to direct the application to maintain and update room bookings for this recurring event indefinitely, or identify one or more conditions that can trigger deactivation of the mechanism. A first section 252 includes fields by which the user can deactivate the auto-booking such as after a specific number of meetings have occurred, after a specific number of weeks or dates, and/or until a specific date or manual deactivation. In addition, a second section 254 allows the user to create exceptions, whereby the auto-booking function can ‘skip’ or otherwise refrain from booking a room on a particular day (e.g., a national holiday, a user's birthday, etc.) or across a range of time, as well as when conditions such as a conflict with another meeting or a determination by the system that the organizer is out of the office that day. In other words, the system can access and review data beyond that directly inputted by a user to intelligently book, modify, or cancel room reservations that match the criteria indicated by the user.

In different implementations, the proposed systems may include provisions for automatically booking, updating, or otherwise modifying rooms for a meeting and notifying a user of such actions. These notifications can occur via a user's electronic calendar, agenda, planner, reminders, to-do list, ‘toasts’ (pop-up messages), or other communications associated with the upcoming meeting. Referring to FIG. 3, an implementation of a notifications mechanism is illustrated. In the upper half of FIG. 3, a calendar 300 is presented in a monthly view, with the days of the week shown above. The calendar 300 includes a plurality of segments, blocks, or boxes, each of which represent one day. For purposes of clarity, FIG. 3 should be understood to make reference to the example described in FIG. 2, where the organizer had scheduled a recurring meeting to occur every Tuesday and Friday. A first meeting date 302 and a second meeting date 304 each identify the room that was manually selected by the organizer (Room 754B).

The organizer had also enabled the auto-reservation function in FIG. 2, requesting that the system find and book a suitable room for all future meetings (past the first two meetings). In some implementations, in performing this task, the system can make reference to the organizer's previous room booking history, rooms that have been identified as ‘favorites’, group policies, updated or real-time availability of rooms, room status, room size or capacity, available resources of room and needs of the event and/or participants, rooms more proximate to the organizer's expected location for that date, rooms nearest to the greatest number of participants, changes in weather that would require an outdoor event to be moved indoors, as well as any other preferences, when making the a determination as to which room to assign to a future meeting.

Thus, with respect to future meeting dates, the system will take into account a variety of factors and preferences of the user and make a determination offline (i.e., in the background, without further user input or interaction) where each meeting will be held. This process can occur at any time prior to the next scheduled meeting. It should be understood that a room assignment can also be automatically revisited and/or modified if another room that is more suitable or closer to the user's preferences (a better or stronger match) becomes available at any time prior to the meeting start time, or up until a “latest” time selected by the user or set as a system default.

The calendar 300 of FIG. 3 reflects one example of an outcome of this process. A third meeting date 306 has been identified as falling on a day when the organizer will be out of the office based on the system's access to and assessment of at least the organizer's emails and/or agenda associated with this date. As a result, no room has been automatically booked for third meeting date 306. In addition, a fourth meeting date 308 has been automatically assigned Room 763D, a fifth meeting date 310 has been automatically assigned Room 752A, and a sixth meeting date 314 has been automatically assigned Room 754A, which are near to the originally selected room and provide the space and resources needed for the meetings. The system has also identified that the originally selected room is now available for a seventh meeting date 312 and an eighth meeting date 318, and has proceeded with auto-booking Room 754B for these meetings. Similar to third meeting date 306, it can be seen that no room has been booked for a ninth meeting date 316, as a result of a conflict with another meeting in which the organizer has indicated attendance that is occurring during the same time, and no room has been booked for a tenth meeting date 320, that falls on a national holiday.

In some implementations, the system may include provisions for calculating and assigning a confidence value to its determination that a particular room will be suitable for the meeting. In one implementation, the system may be configured to automatically book and confirm a room for a meeting, and/or communicate a notification of the room assignment when the confidence value is at or above a pre-specified threshold (e.g., 80%, 87%, 95%, 99%, etc.). If the confidence value falls below the threshold, the system can be configured to book the room (or place a temporary hold) and submit a request to the organizer to confirm whether the room is acceptable. This threshold value can be provided by the system, or can be customized by the user. In another implementation, a first room can be initially booked, and if another, second room that is associated with a greater confidence value becomes available subsequent to this first booking, the system can automatically modify the booking to secure the more suitable or optimal room for the meeting.

As noted earlier, in some implementations, a room booking system may be regulated by various resource usage policies and prevented or blocked from booking rooms beyond a certain date (e.g., 6 weeks from the current date, 2 months from the current date, 1 year from the current date, etc.). In such cases, the auto-booking mechanism can be configured to postpone or ‘pause’ its search for a room for meetings that occur past this date, and then automatically make a booking as soon as the restricted time period has elapsed for an upcoming meeting, thereby ensuring the user is provided with a confirmed room at the earliest time, this feature also increases the likelihood of reserving a room that is best suited to the meeting. In addition, as more users opt to use or otherwise rely on automatic booking, the system can consider or compare the requirements of each meeting, or preferences of each user, across multiple meeting events in the organization to determine the optimal room assignment result for the group as a whole, maximizing the allocation of resources and reducing inter-organization friction.

Of course, in some cases, an organizer may disagree or otherwise dislike the room choice made by the auto-booking system. The system can include provisions for allowing a user to readily access the meeting parameters and manually modify the assigned room. One example of this is illustrated by a selectable icon 340, which when triggered can provide the user with a means of cancelling the booking or searching for a different room. Such an option can be provided at any time prior to the meeting, and may be offered across various notification types.

In different implementations, a conference organization request, reminder, or other notification can be sent to the organizer or invitee(s) (e.g., a meeting invitation, meeting update or change message, meeting alert, etc.), typically including details for the upcoming scheduled meeting. In FIG. 3, an example of a first notification 360 is depicted, whereby the location is identified as the user-selected room (Room 754B). A second notification 362 identifies a different location (Room 763D) and in some implementations, can also include an ‘alert’ symbol (in this case, an exclamation point). Such a symbol can signal to the user that a room different from the originally selected room has been reserved. This is also shown in a third notification 364. When the original room is reserved again on the seventh meeting date 312, no such symbol is shown.

These and other types of meeting notification can be presented at any time prior to the meeting, and can identify the meeting and indicate the location of the meeting as well as any other details that may help the users prepare for the meeting. For example, in the period of time leading up to the meeting, the meeting location may change one or more times, the meeting that had previously had a “TBA” (to be assigned) location status can confirm a room booking, and/or the reservation can transition from a tentative booking to a confirmed booking, as well as other changes. Thus, alerts and notifications can serve an important function in ensuring users are kept up-to-date on the status and location of the meeting, particularly during use of a system that is capable of flexibility during the room booking process.

It can be understood that a large majority of instances in which users schedule meetings and book rooms occur online or electronically. However, users can be somewhat less reliable in returning to a meeting reservation that has been rescheduled offline or cancelled in person (i.e., no update is made electronically) or otherwise ensuring their modified plans are reflected by the booking shown online. As an example, a room most desired by an organizer for a first meeting may not be shown as available due to another reservation made for the same room for a second meeting that overlaps with the meeting time of the first meeting. Even if the second meeting participants are aware that the second meeting has been cancelled or rescheduled or moved to another location (e.g., by word of mouth, over the phone, a sign on a door, in-person communications) and the room is now available, it remains listed as booked. In some implementations, the proposed system can include provisions for verifying the scheduled use of a room is actually occurring in real-time by making reference to room occupancy or motion sensors and/or by reference to user-to-user communications, user location tracking, usage of sick days or vacation days, calendar conflicts, or other such data.

For example, a sensor may detect an activity of a user within the meeting space. The detected activity may be a motion, a sound, a connection of a client device to a communal meeting device, as a few examples. The sensor(s) can be configured to determine whether the meeting space has a scheduled meeting that intersects with a first time period (when the meeting is scheduled), where the first time period starts with the detected activity and ends based on a default time period, pre-set time slots, and a start time of a next scheduled meeting within the meeting space. In some implementations, a sensor may be configured to monitor activity of users within the meeting space, throughout the first time period, and may delete or extend the meeting room reservation based on whether activity within the meeting space is detected throughout and upon the expiration of the first time period. In other words, in one implementation, real-time usage of a resource can be ascertained and used to automatically update the booking system. This can increase an organizer's confidence that the room(s) they most prefer will continue to be considered—even when it has been shown as having been booked elsewhere—and that usage of an organization's space will be maximized at all times.

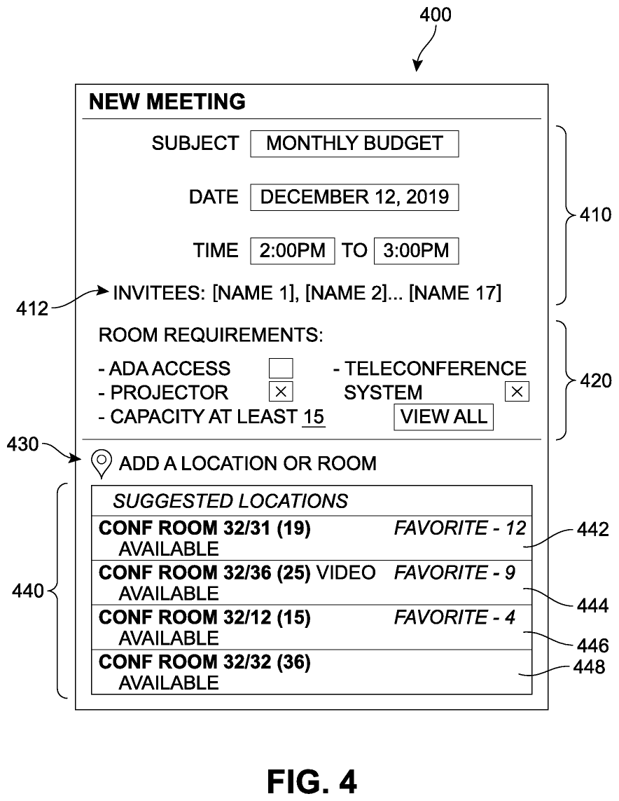

Referring next to FIG. 4, another example of a room booking feature is depicted. As noted above with reference to FIG. 1B, in some implementations, a scheduler interface can be configured to present users with a plurality of available room options (“Suggested Locations”) to expedite the booking process at the time of meeting creation. A representative second meeting user interface (“second interface”) 400 in FIG. 4 includes a meeting itinerary portion 410, which can include a variety of fields or options through which an organizer may input the details of the planned meeting. In the example of FIG. 4, these include a subject field, a set of date and time fields, as well as an invitee listing field 412. The present example also shows a meeting in which 17 invitees have been added.

In different implementations, the system may include provisions for receiving a user's required or preferred room types, access, or tools for the upcoming meeting. For purposes of illustration, in FIG. 4, a Room Requirements section 420 is shown, in which frequently selected room options may be offered, such as ADA Access, Teleconference capability (which has been selected), Projector availability (also selected), and Room capacity (to be of a size to receive at least 15 persons), or others. Many other options may be presented, and all options—as well as customized options—may be viewed via a “View All” or similar option. The options that are shown in the main interface can also be modified by the user, or updated by the system for a specific user based on selection history by the user.

The second interface 400 also includes a location field 430, where a user may manually input or otherwise designate a room or space where the meeting should occur. The user can, for example, type directly into the location field 430 a room or space identifier. In some cases, the initial input of an alphanumeric text may trigger a list of suggestions. In some other implementations, the system may immediately (i.e., without any input from the user) display suggested locations 440 for the user's review, for example in a drop-down menu or pop-up window or other native control. Each suggested location presented can be based at least in part on a user's previous room booking history, rooms that a user has identified as favorite, rooms that have been previously booked for this particular meeting, distance of the room from the participants, and/or room availability. In addition, as discussed above with reference to Room Requirement section 420, a user may also provide guidance or otherwise direct or limit range of rooms that may be suggested.

In this particular example, the suggested locations 440 include a first location 442, a second location 444, a third location 446, and a fourth location 448. The suggested locations 440 can be listed in order of likely preference for this user. In addition, information that is determined to be of relevance to the user can also be presented to facilitate a more efficient room selection. In this case, each location is displayed with a room identifier, the room's suggested or maximum capacity, and indication of its availability. Some locations may also be associated with a ‘favorite’ indicator for the organizer or participant(s) that can help organizers determine which room would be most suitable to the group as a whole. In this example, the first location 442 has been favorited by 12 members of the invitee list, the second location 444 has been favorited by 9 members of the invitee list, and the third location 446 has been favorited by 4 members of the invitee list. By allowing users to share and receive information as they schedule meetings and/or presenting this information during the meeting scheduling process, the likelihood of choosing a room that is optimal for the most, if not all, participants is greatly increased, and the booking process itself is significantly simplified.

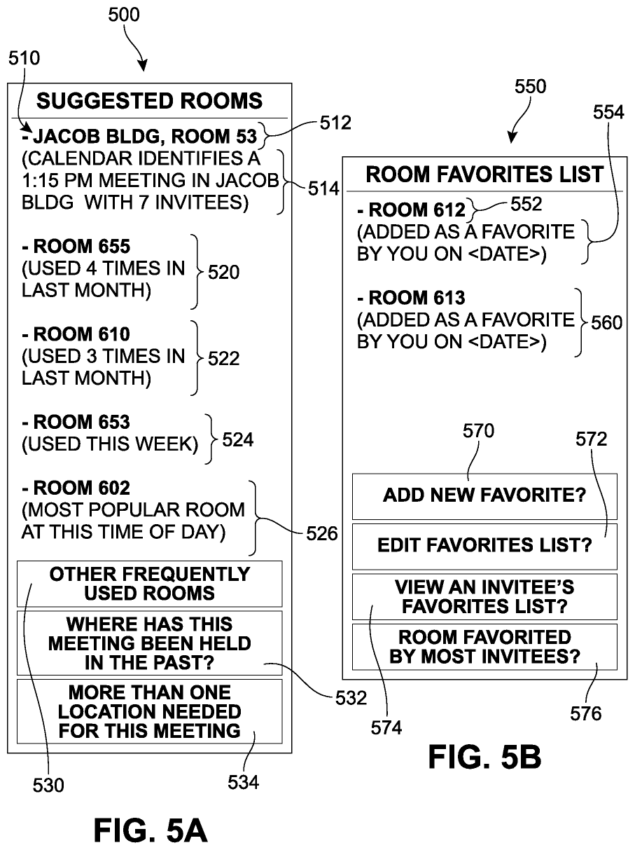

In FIG. 5A, another possible implementation of the suggested location feature is depicted for purposes of clarity. As shown in a suggested rooms interface 500, the rooms listed can be recommended for a wide variety of reasons and presented with many different types of information. A first suggestion 510 is a room 512 located in a different building (“Jacob Bldg, Room 53) than the one the organizer works in. In some implementations, the system can be configured to display a reason as to why this room was a top suggestion via a room description 514. In this case, the room description 514 explains that a review of the organizer's calendar has revealed that the organizer is scheduled to attend a first meeting at 1:15 PM on the same day as the meeting being scheduled for 2 PM, where seven of the 17 invitees for the 2 PM meeting are also attending the 1:15 PM meeting. In other words, the system has determined that the most optimal use of organization's resources—including the organizer's time as well as that of many of the participants—is to reserve a room more proximate to the first meeting.

In different implementations, additional or other rooms can be suggested based on user history, as shown in a second suggestion 520 (used 4 times in the last month), a third suggestion 522 (used 3 times in the last month), and a fourth suggestion 524 (used this week). Furthermore, the system may make use of information regarding overall room popularity or popularity for a specific time of day, as represented by a fifth suggestion 526. In one implementation, each option can be understood to also meet the criteria specified by the user in the Room Requirement section 420 of FIG. 4. Additional options can also be used to allow a user to quickly manage their room booking, including a first selectable option 530 to view other frequently used rooms, a second selectable option 532 to view a listing of rooms that were used for this particular meeting event or type in the past, and/or the ability to book more than one room for a single meeting event, represented by a third selectable option 534, which can allow a user to view suggested rooms adjacent to one another or otherwise recommended for the organizer's needs.

In FIG. 5B, one implementation of a room favorites list interface (“favorites interface”) 550 is shown. As with the suggested rooms interface 500 of FIG. 5A, the rooms listed can be recommended for a wide variety of reasons and presented with many different types of information. A first favorite room 552 is identified along with information 554 about the user's tagging or labeling of this room as a favorite. Similarly, a second favorite room listing 560 is shown below.

In different implementations, additional or other rooms can be added to the list (see a first selectable favorites option 570), and/or the current list can be edited (see a second selectable favorites option 572). Furthermore, in some implementations, and based on privacy or sharing settings for the members of the group, a user may be able to view another invitee's favorites list (see a third selectable favorites option 574), as well as the room that has been favorited by the most users (see a fourth selectable favorites option 576). While the favorites list may provide a broad range of room selections, it should be understood that in some implementations, a user can filter the favorites listing such that only those rooms that match the criteria specified by the user in the Room Requirement section 420 of FIG. 4 and have been identified as a favorite should be shown in the automatic location suggestions.

As introduced above with reference to FIG. 1C, in some implementations, a scheduler interface can be configured with an option to auto-reserve a meeting room for a future meeting that meets a set of ‘vague’ or higher-level criteria. An example of such a system is illustrated in FIG. 6 with a representative third meeting user interface (“third interface”) 600. The third interface 600 includes a meeting itinerary portion 670, which can include a variety of fields or options through which an organizer may input the details of the planned meeting. In the example of FIG. 6, these include a subject field 602, a selectable option 604 to identify this meeting as a recurring event, a date (or day) field 606, a time field 608, and a location field 610.

In different implementations, a user can provide an input to the location field 610 a room or space identifier. In this example, the user has inputted a room ('Room 135”) and a building 614 (“Howard”). In some implementations, the system may update the display of the third interface 600 in real-time to inform the user of the upcoming availability of the selected room for the day/time chosen. An availability notification 620 indicates only that Room 135 is available for the next (upcoming) meeting, but is not able to confirm a booking of that room beyond the next meeting date. This type of situation can occur frequently, and be a source of frustration for organizers, who desire the certainty of a room reservation, and are flexible regarding the actual room that is selected.

The system can, in some implementations, include provisions for enabling auto-booking for a series of meetings without requiring any particular room identification by the organizer. Instead, an organizer can simply indicate a broad location category 680 for the desired room, and the system can take care of the remaining steps. As shown in FIG. 6, the organizer has activated the auto-reserve feature via selectable option 690 (“ON”). In this case, rather than (or in addition to) accessing room history, user activity, and/or favorite lists, etc., the system can be configured to search for rooms within a relatively simple category 630—in which building or larger space does the organizer wish the meeting to be held?

In FIG. 6, the organizer has requested that the meetings be held in a room located in either a first space 632 (“Howard Building”) or a second space 634 (“Jasper Building”). The system can then ensure each week's meeting is automatically assigned a room in either the Howard Building or Jasper Building prior to the event, and provide a timely notification to users of the assigned location. In some implementations, the organizer may be able to include additional general filters, such as rooms on specific floors 640 of each building. In this example, the organizer has requested booking of a room on either the first floor or the eleventh floor in the Howard Building (see first fields 642), or on the second floor in the Jasper Building (see second field 644). In some other implementations, an organizer can also or alternatively request that the system automatically determine where the organizer will be physically located on the next meeting date, and schedule a room that is available nearest to that location, as represented by option 650. In addition, a user may access other options 660, including but not limited to the options described above with respect to FIGS. 2-5.

As noted above, the proposed systems may include provisions for automatically booking, updating, or otherwise modifying rooms for a meeting as well as notifying a user of such changes. Referring to FIG. 7, an implementation of a notification mechanism is illustrated. In the upper half of FIG. 7, a calendar 700 is presented in a monthly view, with the days of the week shown above. The calendar 700 includes a plurality of segments, blocks, or boxes, each of which represent one day. For purposes of clarity, FIG. 7 should be understood to make reference to the example described in FIG. 6, where the organizer had scheduled a recurring meeting to occur weekly on Mondays. A first meeting 710 is shown as assigned to the room that was designated as available and selected by the user (Howard Room 710). It can be understood that in other implementations, all meetings—including the first meeting—can be auto-reserved (i.e., without requiring further input from the user).

The organizer in FIG. 6 had also enabled the auto-reservation function, requesting that the system find and book a suitable room for all future meetings. As described above, the system can search for rooms that are located in the buildings identified by the organizer. This is reflected in the calendar 700, where a second meeting 720 will be held in Room 220 of Jasper, a third meeting 730 will be held in Room 205 of Jasper, a fourth meeting 740 will be held in Room 1114 of Howard, and a fifth meeting 750 will be held in Room 102 of Howard. Thus, per the organizer's request, the rooms that have been automatically booked are located in Howard on the first or eleventh floors, or in Jasper on the second floor.

In different implementations, a conference organization request, reminder, or other notification can be sent to the organizer or invitee(s) (e.g., a meeting invitation, meeting update or change message, meeting alert, etc.), typically including details for the upcoming scheduled meeting. In FIG. 7, an example of a first notification 760, a second notification 762, a third notification 764, and a fourth notification 766 are shown. These and other types of meeting notification can be presented at any time prior to the meeting, and can identify the meeting and indicate the location of the meeting as well as any other details that may help the users prepare for the meeting. For example, in the period of time leading up to the meeting, the meeting location may change one or more times, the meeting that had previously had a “TBA” (to be assigned) location status can confirm a room booking, and/or the reservation can transition from a tentative booking to a confirmed booking, as well as other changes.

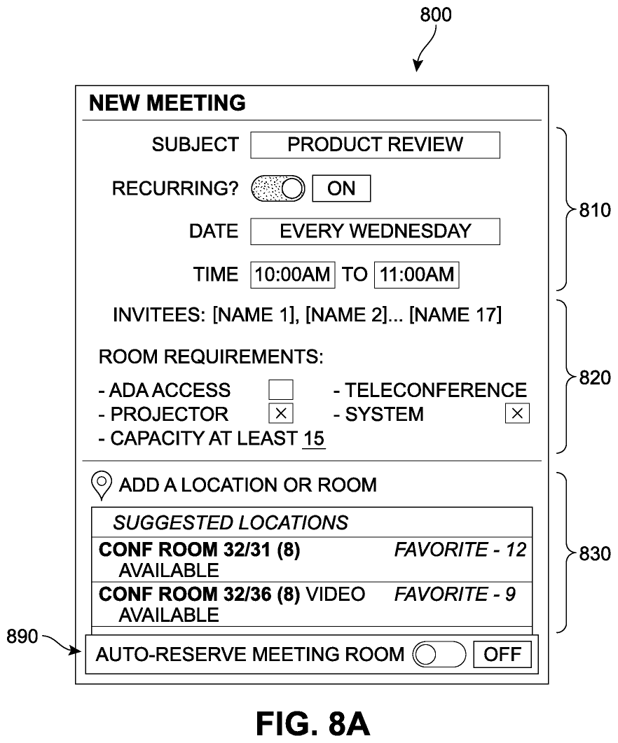

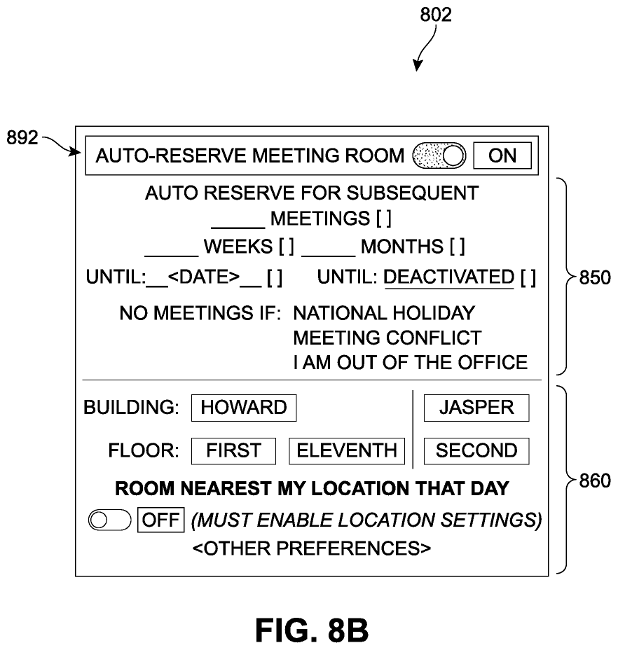

It can be understood that two or more of the features described with respect to each of the disclosed implementations above can be combined to provide a different type of interface. One example of a more ‘comprehensive’ auto-booking system is illustrated in FIGS. 8A and 8B. A first portion 800 of a fourth meeting user interface (“fourth interface”) is shown in FIG. 8A, and a second portion 802 is shown in FIG. 8B. The two portions have been separated for purposes of clarity, but should be understood to represent a unified auto-booking system. The system in this example is configured to offer users the ability to create a meeting via a meeting itinerary portion 810, and identify resources or tools that the meeting room should provide in a Room Requirements section 820. The interface can also present a plurality of suggested locations 830 (see FIGS. 4 and 5). If an auto-reserve option 890 is not selected, the user can simply select a location from the drop-down menu for each meeting date, or return later to add meeting rooms with reference to the suggested locations 830.

If an auto-reserve option 892 is selected, however, as shown in the second portion 802 of FIG. 8B, additional options or features may be provided. For example, an auto-reserve portion 850 can include fields that allow the organizer to permit an automatic management of room bookings for this recurring event indefinitely, and/or identify one or more conditions that can trigger deactivation of the mechanism (see FIGS. 4, 5A, and 5B). Similarly, a broad location category 860 can also be provided (see FIGS. 6 and 7).

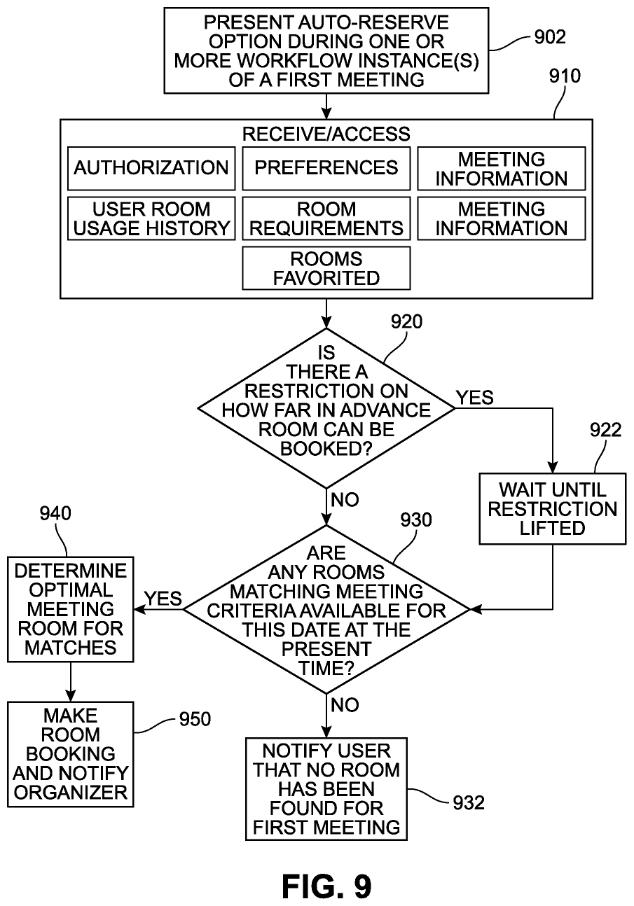

In order to further the reader's understanding of the proposed systems, a schematic flow diagram depicting one implementation of the system is illustrated in FIG. 9. As shown in FIG. 9, in a first step 902, a meeting scheduling management system can be configured to present on a display of a user device an auto-reserve option during one or more workflow instances for a first meeting event. A user can submit their selection(s), where activation of the auto-reserve option corresponds to a user authorization for the system to automatically find a suitable room and book the room for the meeting. This authorization, as well as any user preferences and details of the meeting itself, can be received by the system in a second step 910. From this point forward the system can operate in an ‘offline’ mode, whereby the organizer need not be actively involved in order for the room booking to occur. In some implementations, information associated with user room usage history, room requirements, booking conditions, and favorite rooms can also be accessed and/or received by the system at this and/or other times. The system can ascertain whether the next upcoming meeting is associated with any restrictions related to room booking in a third step 920. If a policy does not allow the system to reserve a room yet, there will be a delay until the restriction period has passed (see a fourth step 922). If there was no such policy, or the policy has now expired, the system can search for any rooms that match the meeting criteria for this date and time in a fifth step 930. This search can occur over an extended period of time in some cases, and can be configured to be auto-performed repeatedly. In some implementations, the search can be run each time a change is made by any user of the booking system, or when the booking system detects any relevant update to the room reservations. In another implementation, the search can be triggered by the release of any room prior to the event.

If, despite a repeated or ongoing search, there are no rooms available that meet the criteria, the system can send a notification to the organizer in a sixth step 932. This provides the organizer an opportunity to perhaps reschedule the meeting, broaden their search parameters, or identify a meeting room manually, or ask a colleague in possession of a desired room during the meeting time to ‘swap’ or make some other arrangements. If, on the other hand, rooms are available, the system can determine which room (if there is more than one) has the greatest likelihood of satisfying the preferences of the user in a seventh step 940. The room can be booked and the organizer notified in an eighth step 950. For example, a notification can be sent to the organizer (and in some cases the participants) confirming the room booking, requesting that the organizer confirm the room is acceptable, or providing the organizer an opportunity to request that the system re-run the search.

As noted earlier, in some implementations, the system can continue to search for rooms that may be a better or closer match, even after identifying and/or booking a room. If a more desirable room is found, and the organizer has authorized automatic modifications of the reservation, the room booking may be automatically updated. If no such authorization was given, the system may send a message to the organizer asking if they would like to ‘upgrade’ the meeting room.

Through the application of such a system, users can be relieved of the stress and expenditure of time needed to find and book a suitable room for any number of future meetings. Users can identify their preferences for various aspects and steps leading to the room reservation, or the system can implement default settings. For example, in some implementations, user or default settings can specify how and when the reservation should be made, as well as what resources should be available in the room. In addition, the system can keep track of the status of each of the rooms, and if a room that has been booked for a future meeting is unexpectedly scheduled for maintenance or is no longer a match for the organizer's needs, the system can automatically search for a new room.

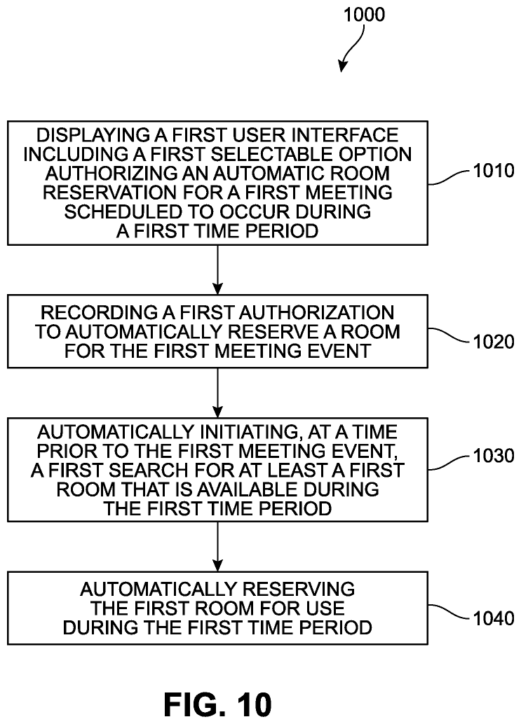

FIG. 10 is a flow chart illustrating an implementation of a method 1000 of managing the automatic connection of users to a conference event. In FIG. 10, a first step 1010 includes causing to be displayed, to a user, a first user interface including a first selectable option. The first selectable option is configured to authorize an automatic room reservation for at least a first meeting event scheduled to occur during a first time period.

A subsequent second step 1020 includes recording, in response to a first user selection of the first selectable option, a first authorization to automatically reserve a room for the first meeting event. A third step 1030 includes automatically initiating, in response to the recorded first authorization and at a time prior to the first meeting event, a first search for at least a first room that is available during the first time period. A fourth step 1040 involves automatically reserving the first room for use during the first time period.

In other implementations, the method can include additional or alternate steps. For example, the first selectable option can further authorize automatic room reservations for each of a plurality of recurring meeting events including the first meeting event and a subsequent second meeting event. In addition, the method may further include automatically initiating, in response to the recorded first authorization and at a time prior to the second meeting event, a second search for at least a second room that is available during a second time period in which the second meeting event is scheduled to occur, as well as automatically reserving the second room for use during the second time period.

Alternatively, the method can include automatically initiating, in response to the recorded first authorization and at a time prior to the second meeting event, a second search for a room that is available during a second time period in which the second meeting event is scheduled to occur, and determining that there is no room available for use during the second time period. In this case, the method can further include automatically transmitting, to the user, a message indicating that no room is currently available for use during the second time period.

As another example, the method may involve accessing a directory of currently authorized users of an automatic room reservation system, and then determining, based on the accessing of the directory, that the user is no longer an authorized user. In this case, the method can also include automatically canceling the reservation of the first room. In some implementations, the method may involve accessing a resource usage policy associated with an automatic room reservation system, and then determining, based on the accessing of the resource usage policy, that there is a policy precluding reservation of a room for the first meeting for a predetermined period of time prior to the start time of the first meeting. In this case, the method can further include delaying the initiation of the first search until after the expiration of the predetermined period of time.

In another example, the method can include receiving, from the user, a first room criterion, and then creating, in response receiving the first room criterion, a first filter configured to automatically limit the first search to rooms that meet the first room criterion. The method can also include automatically applying the first filter to the first search when the first search is initiated. In some implementations, the first room criterion can correspond to a requirement or preference, for example by the user, that the first room include one or more of a teleconferencing system, a minimum room capacity, and accessibility for persons with disabilities. In another implementation, the first room criterion can correspond to a requirement or preference, for example by the user, that the first room be located within a specific building.

Furthermore, in some implementations, the method may involve detecting, after the reserving of the first room, a change in room availability for the first time period, and then automatically initiating, in response to the detection of the change in room availability, a second search for at least a second room that is available during the first time period. In addition, the method can include determining the second room is a better match with the first room criterion than the first room. This can be based on a comparison of the confidence value assigned to the first room and with the confidence value assigned to the second room in some implementations. In another implementation, this can be based on a determination that the second room is more proximate to the user's location on the date of the first meeting than the first room. In one implementation, this can be based on a higher number of preferences being matched or met by the second room relative to the first room. The method may also include automatically reserving the second room for use during the first time period, and automatically canceling the reservation of the first room. In some implementations, the detection of the change in room availability is based on data obtained by an occupancy sensor associated with the second room, while in other implementations, the cancellation of a room booking for another meeting event can trigger the detection of the change in room availability.

In another implementation, the method can involve detecting, after the reserving of the first room, a change in status for the first room, and then automatically initiating, in response to the detection of the change in status, a second search for at least a second room that is available during the first time period. In addition, the method can include automatically reserving the second room for use during the first time period, and automatically canceling the reservation of the first room.

It should be understood that in different implementations, the method can vary. For example, another method that is within the scope of this application directed toward facilitating selections of meeting rooms includes a first step of causing to be displayed, to a user, a first user interface. The first user interface include a first input field for scheduling a time for a first meeting event and a second input field for selecting required meeting room resources. The method also includes receiving a start time and an end time for the first meeting event via the first input field, and receiving a first room criterion via the second input field. In addition, the method may involve automatically initiating, in response to receiving the start time, the end time, and the first room criterion, a first search for one or more rooms that are available for use during the first meeting event and meet the first room criterion. Furthermore, the method can include causing to be displayed, to the user, a list of suggested meeting rooms, where the list of suggested meeting rooms include a first room of the one or more rooms that is available for use during the first meeting event and meets the first room criterion. In some implementations, the method may further include accessing a list of preferred rooms for the user, and causing to be displayed, to the user, a second room of the one or more rooms that is available for use during the first meeting event and is on the list of preferred rooms.

As a general matter, an example system for management of room reservations for meetings can include or access a network environment. As one non-limiting example, a system can include a data center that can host a cloud-based communication service configured to enable users to share content, interact and communicate with one another, create and share calendars, and schedule meetings, among other things, through various communication modes, such as e-mail, text message, call and video conferencing and the like. A datacenter can include one or more processing servers that are configured to execute various communication services. In one implementation, a processing server is operable to execute a reservation module associated with the communication service. The data center may also include one or more storage servers configured to manage one or more data stores comprising data associated with content stored by the communication service and/or data associated with the reservation module. Furthermore, the communication service(s) and/or reservation module(s) may be implemented as software, hardware, or combinations thereof.

In some implementations, the communication service may be configured to inter-operate with different applications in order to provide its services. For example, a client application may be an application hosted by the communication service such as a calendaring application. There may also be a sensor detection module configured to process signals received from sensors and/or inputs from the meeting rooms. The sensors may include motion detectors, proximity sensors, optical sensors, cameras, microphones, near-field communication (NFC) devices, and/or Bluetooth devices, among other types of sensors. The inputs may include a high-definition multimedia interface (HDMI) port, and software entry points, among other types of inputs. A detection module may be configured to process the signals received from the sensors to detect an activity of the users within various meeting spaces. In some other implementations, a detection module may be configured to determine an identity of the users within a meeting space by processing signals received from the sensors. For example, users may be wearing employee badges with a barcode, or provide biometric input such as finger printing, facial recognition, voice recognition, and iris recognition, among other examples.

Use of the disclosed systems and methods can enable users to schedule meetings for some future date and be presented an option to auto-reserve a physical space for each meeting. In other words, in conjunction with their establishing the details of a meeting such as date, time, invitees, etc., a user can easily opt to enjoy the convenience of automatic room reservations for each meeting date. The user no longer needs to search through different rooms, determine which rooms accommodate the needs of their meeting and participants. The ability to deliberately select this option for individual or recurring meetings during the process of creating a meeting offers a wide range of benefits to organizers. This feature substantially reduces the time needed to organize and prepare for the meeting, the stress of finding a room that includes the resources desired by the organizer, and the aggravation of following up on each individual future meeting and ensuring a room has been booked. Furthermore, users are offered a straightforward means by which to implement their preferences for selecting a room, as well as the ability to easily change one's mind about their preferred rooms or resources.

For the sake of simplicity of description, details are not provided herein for performing various connection processes and the configuration of different telecommunication components. Implementations of the present disclosure can make use of any of the features, systems, components, devices, and methods described in U.S. Patent Publication Number 2018/0253666 to Fix, published Sep. 6, 2018 and entitled “Automatic reservation of meeting space through communal meeting device”; U.S. Patent Publication Number 2016/0180259 to Marianko et al., published Jun. 23, 2016 and entitled “Real-time Automatic Meeting Room Reservation Based on the Number of Actual Participants”; U.S. Patent Publication Number 2015/0186850 to Ramji, published Jul. 2, 2015 and entitled “Smart Meeting Creation and Management”; U.S. Patent Publication Number 2009/0299807 to Schiller et al., published on Dec. 3, 2009 and entitled “Scheduling opportunity previewer”; U.S. Patent Publication Number 2017/0308866 to Dotan-Cohen et al., published on Oct. 26, 2017 and entitled “Meeting Scheduling Resource Efficiency”; U.S. Pat. No. 7,707,256 to Rollin et al., issued on Apr. 27, 2010 and entitled “Suggesting meeting locations for conducting meetings”; U.S. Pat. No. 9,578,461 to Benzatti et al., issued on Feb. 21, 2017 and entitled “Location context, supplemental information, and suggestions for meeting locations”; U.S. Pat. No. 9,760,870 to Nortan et al., issued on Sep. 12, 2017 and entitled “Systems and methods for scheduling events”; U.S. Patent Publication Number 2015/0058425 to Nathan et al., published on Feb. 26, 2015 and entitled “Smart meeting service”; U.S. Patent Publication Number 2008/0133282 to Landar et al., published on Jun. 5, 2008 and entitled “Meeting resource scheduling based upon attendance participation types”; U.S. Patent Publication Number 2012/0078676 to Adams et al., published on Mar. 29, 2012 and entitled “Meeting room scheduling system including room occupancy sensor and related methods”; U.S. Pat. No. 8,041,586 to Jethani et al., issued on Oct. 18, 2011 and entitled “Shared space availability by dynamically responding to user utilization behavior of saved space”; U.S. Pat. No. 7,693,736 to Chu et al., issued on Apr. 6, 2010 and entitled “Recurring meeting schedule wizard”; and U.S. Pat. No. 9,626,660 to Bathiya et al., issued on Apr. 18, 2017 and entitled “Conflict management in scheduling meetings”; as well as each of their disclosed methods and systems for the management of meetings and room reservations and so forth, the disclosures of each of which are herein incorporated by reference in their entirety.

The detailed examples of systems, devices, and techniques described in connection with FIGS. 1-10 are presented herein for illustration of the disclosure and its benefits. Such examples of use should not be construed to be limitations on the logical process implementations of the disclosure, nor should variations of user interface methods from those described herein be considered outside the scope of the present disclosure. In some implementations, various features described in FIGS. 1-10 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

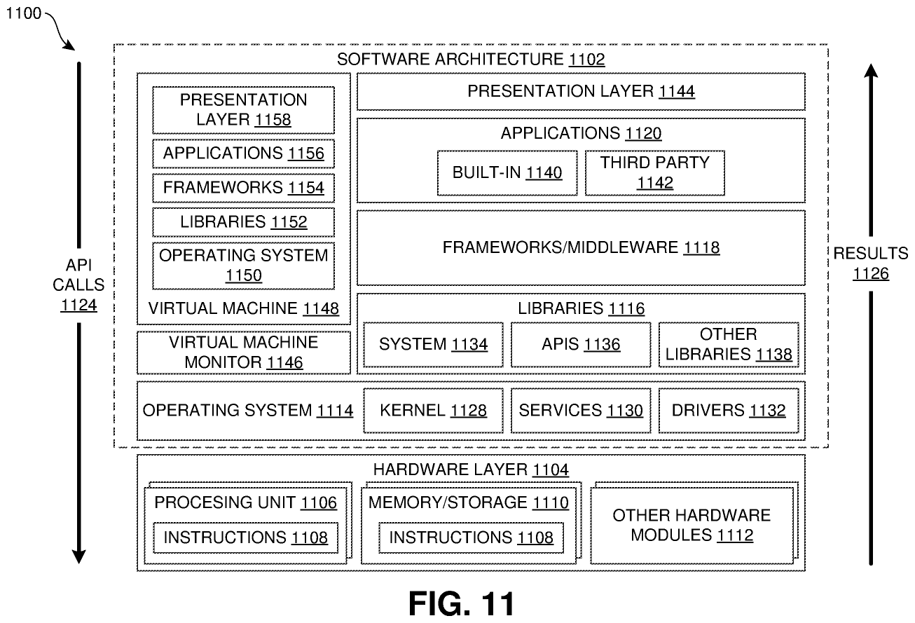

FIG. 11 is a block diagram 1100 illustrating an example software architecture 1102, various portions of which may be used in conjunction with various hardware architectures herein described, which may implement any of the above-described features. FIG. 11 is a non-limiting example of a software architecture and it will be appreciated that many other architectures may be implemented to facilitate the functionality described herein. The software architecture 1102 may execute on hardware such as a device 120 of FIG. 1 that includes, among other things, document storage 1070, processors, memory, and input/output (I/O) components. A representative hardware layer 1104 is illustrated and can represent, for example, the device 120 of FIG. 1. The representative hardware layer 1104 includes a processing unit 1106 and associated executable instructions 1108. The executable instructions 1108 represent executable instructions of the software architecture 1102, including implementation of the methods, modules and so forth described herein. The hardware layer 1104 also includes a memory/storage 1110, which also includes the executable instructions 1108 and accompanying data. The hardware layer 1104 may also include other hardware modules 1112. Instructions 1108 held by processing unit 1108 may be portions of instructions 1108 held by the memory/storage 1110.

The example software architecture 1102 may be conceptualized as layers, each providing various functionality. For example, the software architecture 1102 may include layers and components such as an operating system (OS) 1114, libraries 1116, frameworks 1118, applications 1120, and a presentation layer 1144. Operationally, the applications 1120 and/or other components within the layers may invoke API calls 1124 to other layers and receive corresponding results 1126. The layers illustrated are representative in nature and other software architectures may include additional or different layers. For example, some mobile or special purpose operating systems may not provide the frameworks/middleware 1118.

The OS 1114 may manage hardware resources and provide common services. The OS 1114 may include, for example, a kernel 1128, services 1130, and drivers 1132. The kernel 1128 may act as an abstraction layer between the hardware layer 1104 and other software layers. For example, the kernel 1128 may be responsible for memory management, processor management (for example, scheduling), component management, networking, security settings, and so on. The services 1130 may provide other common services for the other software layers. The drivers 1132 may be responsible for controlling or interfacing with the underlying hardware layer 1104. For instance, the drivers 1132 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1116 may provide a common infrastructure that may be used by the applications 1120 and/or other components and/or layers. The libraries 1116 typically provide functionality for use by other software modules to perform tasks, rather than rather than interacting directly with the OS 1114. The libraries 1116 may include system libraries 1134 (for example, C standard library) that may provide functions such as memory allocation, string manipulation, file operations. In addition, the libraries 1116 may include API libraries 1136 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1116 may also include a wide variety of other libraries 1138 to provide many functions for applications 1120 and other software modules.

The frameworks 1118 (also sometimes referred to as middleware) provide a higher-level common infrastructure that may be used by the applications 1120 and/or other software modules. For example, the frameworks 1118 may provide various graphic user interface (GUI) functions, high-level resource management, or high-level location services. The frameworks 1118 may provide a broad spectrum of other APIs for applications 1120 and/or other software modules.

The applications 1120 include built-in applications 1140 and/or third-party applications 1142. Examples of built-in applications 1140 may include, but are not limited to, a contacts application, a browser application, a location application, a media application, a messaging application, and/or a game application. Third-party applications 1142 may include any applications developed by an entity other than the vendor of the particular platform. The applications 1120 may use functions available via OS 1114, libraries 1116, frameworks 1118, and presentation layer 1144 to create user interfaces to interact with users.

Some software architectures use virtual machines, as illustrated by a virtual machine 1148. The virtual machine 1148 provides an execution environment where applications/modules can execute as if they were executing on a hardware machine (such as the machine 1000 of FIG. 10, for example). The virtual machine 1148 may be hosted by a host OS (for example, OS 1114) or hypervisor, and may have a virtual machine monitor 1146 which manages operation of the virtual machine 1148 and interoperation with the host operating system. A software architecture, which may be different from software architecture 1102 outside of the virtual machine, executes within the virtual machine 1148 such as an OS 1150, libraries 1152, frameworks 1154, applications 1156, and/or a presentation layer 1158.

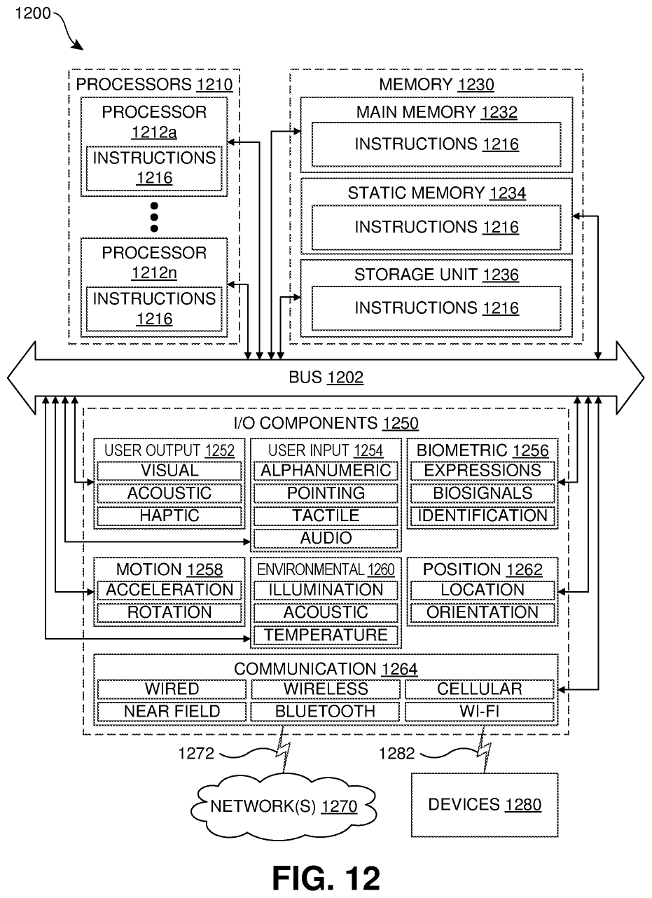

FIG. 12 is a block diagram illustrating components of an example machine 1200 configured to read instructions from a machine-readable medium (for example, a machine-readable storage medium) and perform any of the features described herein. The example machine 1200 is in a form of a computer system, within which instructions 1216 (for example, in the form of software components) for causing the machine 1200 to perform any of the features described herein may be executed. As such, the instructions 1216 may be used to implement modules or components described herein. The instructions 1216 cause unprogrammed and/or unconfigured machine 1200 to operate as a particular machine configured to carry out the described features. The machine 1200 may be configured to operate as a standalone device or may be coupled (for example, networked) to other machines. In a networked deployment, the machine 1200 may operate in the capacity of a server machine or a client machine in a server-client network environment, or as a node in a peer-to-peer or distributed network environment. Machine 1200 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1200 is illustrated, the term “machine” include a collection of machines that individually or jointly execute the instructions 1216.

The machine 1200 may include processors 1210, memory 1230, and I/O components 1250, which may be communicatively coupled via, for example, a bus 1202. The bus 1202 may include multiple buses coupling various elements of machine 1200 via various bus technologies and protocols. In an example, the processors 1210 (including, for example, a central processing unit (CPU), a graphics processing unit (GPU), a digital signal processor (DSP), an ASIC, or a suitable combination thereof) may include one or more processors 1212a to 1212n that may execute the instructions 1216 and process data. In some examples, one or more processors 1210 may execute instructions provided or identified by one or more other processors 1210. The term “processor” includes a multi-core processor including cores that may execute instructions contemporaneously. Although FIG. 12 shows multiple processors, the machine 1200 may include a single processor with a single core, a single processor with multiple cores (for example, a multi-core processor), multiple processors each with a single core, multiple processors each with multiple cores, or any combination thereof. In some examples, the machine 1200 may include multiple processors distributed among multiple machines.

The memory/storage 1230 may include a main memory 1232, a static memory 1234, or other memory, and a storage unit 1236, both accessible to the processors 1210 such as via the bus 1202. The storage unit 1236 and memory 1232, 1234 store instructions 1216 embodying any one or more of the functions described herein. The memory/storage 1230 may also store temporary, intermediate, and/or long-term data for processors 1210. The instructions 1216 may also reside, completely or partially, within the memory 1232, 1234, within the storage unit 1236, within at least one of the processors 1210 (for example, within a command buffer or cache memory), within memory at least one of I/O components 1250, or any suitable combination thereof, during execution thereof. Accordingly, the memory 1232, 1234, the storage unit 1236, memory in processors 1210, and memory in I/O components 1250 are examples of machine-readable media.

As used herein, “machine-readable medium” refers to a device able to temporarily or permanently store instructions and data that cause machine 1200 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1216) for execution by a machine 1200 such that the instructions, when executed by one or more processors 1210 of the machine 1200, cause the machine 1200 to perform and one or more of the features described herein. Accordingly, a “machine-readable medium” may refer to a single storage device, as well as “cloud-based” storage systems or storage networks that include multiple storage apparatus or devices.

The I/O components 1250 may include a wide variety of hardware components adapted to receive input, provide output, produce output, transmit information, exchange information, capture measurements, and so on. The specific I/O components 1250 included in a particular machine will depend on the type and/or function of the machine. For example, mobile devices such as mobile phones may include a touch input device, whereas a headless server or IoT device may not include such a touch input device. The particular examples of I/O components illustrated in FIG. 12 are in no way limiting, and other types of components may be included in machine 1200. The grouping of I/O components 1250 are merely for simplifying this discussion, and the grouping is in no way limiting. In various examples, the I/O components 1250 may include user output components 1252 and user input components 1254. User output components 1252 may include, for example, display components for displaying information (for example, a liquid crystal display (LCD) or a projector), acoustic components (for example, speakers), haptic components (for example, a vibratory motor or force-feedback device), and/or other signal generators. User input components 1254 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1250 may include biometric components 1256 and/or position components 1262, among a wide array of other environmental sensor components. The biometric components 1256 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1262 may include, for example, location sensors (for example, a Global Position System (GPS) receiver), altitude sensors (for example, an air pressure sensor from which altitude may be derived), and/or orientation sensors (for example, magnetometers).

The I/O components 1250 may include communication components 1264, implementing a wide variety of technologies operable to couple the machine 1200 to network(s) 1270 and/or device(s) 1280 via respective communicative couplings 1272 and 1282. The communication components 1264 may include one or more network interface components or other suitable devices to interface with the network(s) 1270. The communication components 1264 may include, for example, components adapted to provide wired communication, wireless communication, cellular communication, Near Field Communication (NFC), Bluetooth communication, Wi-Fi, and/or communication via other modalities. The device(s) 1280 may include other machines or various peripheral devices (for example, coupled via USB).

In some examples, the communication components 1264 may detect identifiers or include components adapted to detect identifiers. For example, the communication components 1264 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1262, such as, but not limited to, geo-location via Internet Protocol (IP) address, location via Wi-Fi, cellular, NFC, Bluetooth, or other wireless station identification and/or signal triangulation.

Furthermore, implementations of the present disclosure can make use of any of the features, systems, components, devices, and methods described in U.S. Pat. No. 8,660,978 to Hinckley et al., issued Feb. 25, 2014 and titled “Detecting and Responding to Unintentional Contact with a Computing Device,” the disclosure of which is herein incorporated by reference in its entirety.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A system comprising:
at least one processor; and
one or more computer readable media including instructions which, when executed by the at least one processor, cause the at least one processor to:
cause to be displayed, to a user, a first user interface including a first selectable option authorizing an automatic room reservation for at least a first meeting event scheduled to occur during a first time period;
record, in response to a first user selection of the first selectable option, a first authorization to automatically reserve a room for the first meeting event;
automatically initiate, in response to the recorded first authorization and at a time prior to the first meeting event, a first search for at least a first room that is available during the first time period; and
automatically reserve the first room for use during the first time period.

2. The system of claim 1, wherein the instructions further cause the at least one processor to:
access a directory of currently authorized users of an automatic room reservation system;
determine, based on the accessing of the directory, that the user is no longer an authorized user; and
automatically cancel the reservation of the first room.

3. The system of claim 1, wherein the instructions further cause the at least one processor to:
access a resource usage policy associated with an automatic room reservation system;
determine, based on the accessing of the resource usage policy, that there is a policy precluding reservation of a room for the first meeting for a predetermined period of time prior to the start time of the first meeting; and
delay the initiation of the first search until after the expiration of the predetermined period of time.

4. The system of claim 1, wherein the instructions further cause the at least one processor to:
receive, from the user, a first room criterion;
create, in response to receiving the first room criterion, a first filter configured to automatically limit the first search to rooms that meet the first room criterion; and
automatically apply the first filter to the first search when the first search is initiated.

5. The system of claim 4, wherein the first room criterion requires that the first room include one of a teleconferencing system, a minimum room capacity, and accessibility for persons with disabilities.

6. The system of claim 4, wherein the first room criterion requires that the first room be located within a specific building.

7. The system of claim 4, wherein the instructions further cause the at least one processor to:
detect, after the reserving of the first room, a change in room availability for the first time period;
automatically initiate, in response to the detection of the change in room availability, a second search for at least a second room that is available during the first time period;
determine the second room is a better match with the first room criterion than the first room;
automatically reserve the second room for use during the first time period; and
automatically cancel the reservation of the first room.

8. A method of reserving a room for a meeting, the method comprising:
causing to be displayed, to a user, a first user interface including a first selectable option authorizing an automatic room reservation for at least a first meeting event scheduled to occur during a first time period;
recording, in response to a first user selection of the first selectable option, a first authorization to automatically reserve a room for the first meeting event;
automatically initiating, in response to the recorded first authorization and at a time prior to the first meeting event, a first search for at least a first room that is available during the first time period; and
automatically reserving the first room for use during the first time period.

9. The method of claim 8, wherein the first selectable option further authorizes automatic room reservations for each of a plurality of recurring meeting events including the first meeting event and a subsequent second meeting event; and
the method further comprises:
automatically initiating, in response to the recorded first authorization and at a time prior to the second meeting event, a second search for at least a second room that is available during a second time period in which the second meeting event is scheduled to occur; and
automatically reserving the second room for use during the second time period.

10. The method of claim 8, wherein the first selectable option further authorizes automatic room reservations for each of a plurality of meeting events including the first meeting event and a subsequent second meeting event; and
the method further comprises:
automatically initiating, in response to the recorded first authorization and at a time prior to the second meeting event, a second search for a room that is available during a second time period in which the second meeting event is scheduled to occur;
determining that there is no room available for use during the second time period; and
automatically transmitting, to the user, a message indicating that no room is currently available for use during the second time period.

11. The method of claim 8, further comprising:
accessing a directory of currently authorized users of an automatic room reservation system;
determining, based on the accessing of the directory, that the user is no longer an authorized user; and
automatically canceling the reservation of the first room.

12. The method of claim 8, further comprising:
accessing a resource usage policy associated with an automatic room reservation system;
determining, based on the accessing of the resource usage policy, that there is a policy precluding reservation of a room for the first meeting for a predetermined period of time prior to the start time of the first meeting; and
delaying the initiation of the first search until after the expiration of the predetermined period of time.

13. The method of claim 8, further comprising:
receiving, from the user, a first room criterion;
creating, in response receiving the first room criterion, a first filter configured to automatically limit the first search to rooms that meet the first room criterion; and
automatically applying the first filter to the first search when the first search is initiated.

14. The method of claim 13, wherein the first room criterion requires that the first room include one of a teleconferencing system, a minimum room capacity, and accessibility for persons with disabilities.

15. The method of claim 13, wherein the first room criterion requires that the first room be located within a specific building.

16. The method of claim 13, further comprising:
detecting, after the reserving of the first room, a change in room availability for the first time period;
automatically initiating, in response to the detection of the change in room availability, a second search for at least a second room that is available during the first time period;
determining the second room is a better match with the first room criterion than the first room;
automatically reserving the second room for use during the first time period; and
automatically canceling the reservation of the first room.

17. The method of claim 8, wherein the detection of the change in room availability is based on data obtained by an occupancy sensor associated with the second room.

18. The method of claim 8, further comprising:
detecting, after the reserving of the first room, a change in status for the first room;
automatically initiating, in response to the detection of the change in status, a second search for at least a second room that is available during the first time period;
automatically reserving the second room for use during the first time period; and
automatically canceling the reservation of the first room.

19. A method of facilitating room selection for a meeting, the method comprising:
causing to be displayed, to a user, a first user interface including a first input field for scheduling a time for a first meeting event and a second input field for selecting required meeting room resources;
receiving a start time and an end time for the first meeting event via the first input field;
receiving a first room criterion via the second input field;
automatically initiating, in response to receiving the start time, the end time, and the first room criterion, a first search for one or more rooms that are available for use during the first meeting event and meet the first room criterion; and
causing to be displayed, to the user, a list of suggested meeting rooms, the list of suggested meeting rooms including a first room of the one or more rooms that is available for use during the first meeting event and meets the first room criterion.

20. The method of claim 18, further comprising:
accessing a list of preferred rooms for the user; and
causing to be displayed, to the user, a second room of the one or more rooms that is available for use during the first meeting event and is on the list of preferred rooms.
